(19) United States
(12) Patent Application Publication
(10) Pub. No.: US 2007/0023548 A1
(43) Pub. Date: Feb. 1, 2007

(54) Stemmed-Nozzle

(76) Inventor: Hanna Yaacoub Hajjar, Tarzana, CA (US)

Correspondence Address: HANNA Y. HAJJAR, 6258 CALVIN AVE., TARZANA, CA, 91335, US

(21) Appl. No.: 11/161,370

(22) Filed: Aug. 1, 2005

(51) Int. Cl. B05B 1/00

(52) U.S. Cl. 239/600; 239/589

(57) ABSTRACT

The Stemmed-Nozzle consists of a nozzle that is attached to a cylindrical hollow rigid stem, together forming one integral part that can then be inserted into Quick-Connect fittings (of matching size) to create a misting or fogging systems (in conjunction with necessary tubing and pressurized water source). It can be dimensioned to fit standard sizes of Quick-Connect Fittings, and can be used with liquids and gases.

### FIELD OF THE INVENTION

The present invention relates to a new way of making, applying or using nozzles for misting and fogging. More particularly, the present invention relates to utilizing the Stemmed-nozzle in conjunction with Quick-Connect fittings offering economical way to manufacture nozzles, and a quick, secure, easy, and assemble them with fittings and tubing to form misting or fogging systems.

### BACKGROUND INFORMATION

Misting has been around for a long time, and it is used for different applications, cooling of humans and animals, spraying, evaporative cooling, irrigation, humidifying, fogging etc. Conventional nozzles come as Threaded, Barbed or Soldered, and that is how they are attached to fittings, piping or tubing.

The Threaded-Nozzles come normally with a male thread at the back of the nozzle which is screwed into a female threaded fitting, or is directly tapped into pipes. There is an O-ring at the base of the nozzle's male thread, which acts as a seal to prevent water (or any liquid or gas) from leaking.

The Barbed-Nozzles come with a barb at the back of the nozzle, which is pushed into a flexible plastic tube, then clamped using a metal or plastic clamp over the barb to secure it in place, and prevent the nozzle from popping out as the pressure of the water builds up behind it, this feature limits its application to lower pressure systems.

The Soldered-Nozzles is another method used for assembling nozzles, and that is by having a nozzle soldered directly to a pipe, or a hollow female threaded metal stem (normally brass) is used as a cap over the end of a metal pipe (normally copper), the metal stem is soldered over the pipe end, (where the pipe acts like a nipple, and the stem acts as its cap), then the nozzle is threaded into that soldered stem. Sometimes a female threaded molded plastic hollow stems is used instead of the metal stem, this is used in the case of low pressure systems, where the plastic is glued as a cap over the end of a metal pipe, then the nozzle is threaded into that threaded molded plastic stem. In all these cases the stem is used as a cap over the end of a pipe. In other words the inside diameter of these stems is slightly larger than the outside diameter of the pipe to allow it to act as its cap.

Traditionally the ways current misters are used is not cost effective, and are not utilizing the latest innovation in technology, namely the quick-connect fittings. The problem with Threaded-Nozzles is that they require machined threaded metal fittings or special molded threaded plastic fittings with female thread to match the male threads of the nozzles. Then they require the labor of screwing them into the fitting or tapped pipes. On the other hand the Soldered-Nozzles type requires the labor of soldering plus the screwing in of the nozzle. The Barbed-Nozzles on the other hand are used with soft plastic tubing and require a clamp around the barb, limiting their application to the end-of-line misting, and with lower presser systems.

Thus, an improved method of making misters is necessary, and a new system of misters is needed.

### OBJECTS AND ADVANTAGES

For the purpose of this patent application, the term Stemmed-Nozzle is defined as an assembly of a nozzle with a hollow cylindrical stem to which a nozzle is attached to and secured, forming one integral item. This allows it to be inserted inside a Quick-Connect fitting, where the fitting acts like a cap to the stem, and the stem acts as a slip-in insert. The Quick-Connect fitting's internal mechanism parts lock the stem inside it, while the stem's hollow inside acts as the passage way for water (or any liquid or gas) to flow through.
(1) The main unique feature of Stemmed-Nozzle is that it is unlike the conventional nozzle it has a unique look, due to being a mister with a stem combined as an integral part.
(2) With Stemmed-Nozzle, the outside diameter of the stem is utilized in securing it inside the fitting while the fitting acts as its cap. This is opposite to the conventional way used in soldering (or gluing) where their stem acts like a cap to a pipe.
(3) Stemmed-Nozzle is very easy to assemble; all it takes is pushing its stem into a quick-connect fitting (of matching size) all the way in, and that locks it in place securely, through an O-ring and collet ring with toothed insert that lock the stem in place, with no leaks.
(4) Stemmed-Nozzle can be assembled with a plastic or metal quick-connect fitting that in turn is connected to semi-rigid, rigid plastic tubing, or rigid metal tubing, through which water is passed to generate the mist. This process of assembling does not require screwing-in, soldering, or clamping, just push the Stemmed-Nozzle all the way into the fitting to lock it in, and hence less labor is involved.
(5) By utilizing the Stem as an insert rather than a cap, (and specifically in the case of plastic stems), this upgrades the pressure capacity that the Nozzle can withstand, because its stem is enveloped and reinforced by the walls of the fitting.
(6) By using the Stemmed-Nozzle with Tee Fittings the application of Barbed-Nozzles is expanded from end-of-line application, to allowing them to be placing anywhere along the line.
(7) Just as the Stemmed-Nozzle is connected very quickly (by pushing it all the way into the fitting), it can also be disconnected very quickly too, by simply pushing the collet against the fitting and simultaneously pulling the Stemmed-Nozzle out. This becomes very handy when maintaining the misters against lime build up, where the Stemmed-Nozzles are easily removed and soaked in lime removal solutions. It also becomes handy for winterizing, (removal of the misters for the winter season). Or removal for cleaning in case of clogging occurs due to the presence of sediment in water.

### BRIEF DESCRIPTION OF THE DRAWINGS

The present invention is illustrated by a way of example in the following drawings in which references indicate similar elements. The following drawings disclose various embodiments of the invention for the purpose of illustration only and are not indeed to limit the scope of the invention.

FIG. 1 illustrates the two common types of nozzles applied to rigid Hollow-Cylindrical stems that match them.

FIG. 1A illustrates a Hollow-Cylindrical Stem.

FIG. 1B illustrates a Barbed-Nozzle and a Hollow-Cylindrical stem.

FIG. 1C illustrates a Threaded-Nozzle and a threaded Hollow-Cylindrical stem.

FIG. 1D illustrates an assembled Stemmed-Barbed-Nozzle.

FIG. 1E illustrates an assembled Stemmed-Nozzle in 3-D.

FIG. 2 illustrates a Misting system with Stemmed-Nozzles attached to quick-connect fittings that in turn are attached to tubing.

### REFERENCE NUMERALS IN DRAWINGS

101 Rigid Hollow-Cylindrical Stem.
102 Barbed-Nozzle.
103 Threaded-Nozzle.
104 Quick-Connect Elbow.
105 Quick-connect Tee.
106 Tubing.
107 Mist or Fog.
108 Rubber O-Ring.
109 Threaded Hollow-Cylindrical Stem.

### SUMMARY OF THE INVENTION

The present invention describes a method and apparatus to provide a cost effective economical way of making Stemmed-Nozzles, and using them with Quick-Connect Fittings and Tubing to build misting or fogging systems that have a wide variety of applications. In one embodiment of the present invention, the Stemmed-Mister is utilized in a patio misting system that offers cooling, by dropping the temperature inside the patio space about 25 degrees from the surrounding ambient temperature.

### DETAILED DESCRIPTION

The following description describes the Stemmed-Nozzle, as well as the way to assemble it. The following detailed description sets forth numerous specific details to provide a thorough understanding of the invention. However those skilled in the art will appreciate that the invention may be practiced without these specific details. In other instances, well-known methods, procedures, protocols, components, and items have not been described in detail so as not to obscure the invention.

Although particular embodiment of the invention will be discussed, with reference to making stemmed-Nozzles, those of ordinary skill in the art will appreciate that the present invention may be utilized in other types of applications. In particular the teachings of the present invention may be applied to other devices and applications.

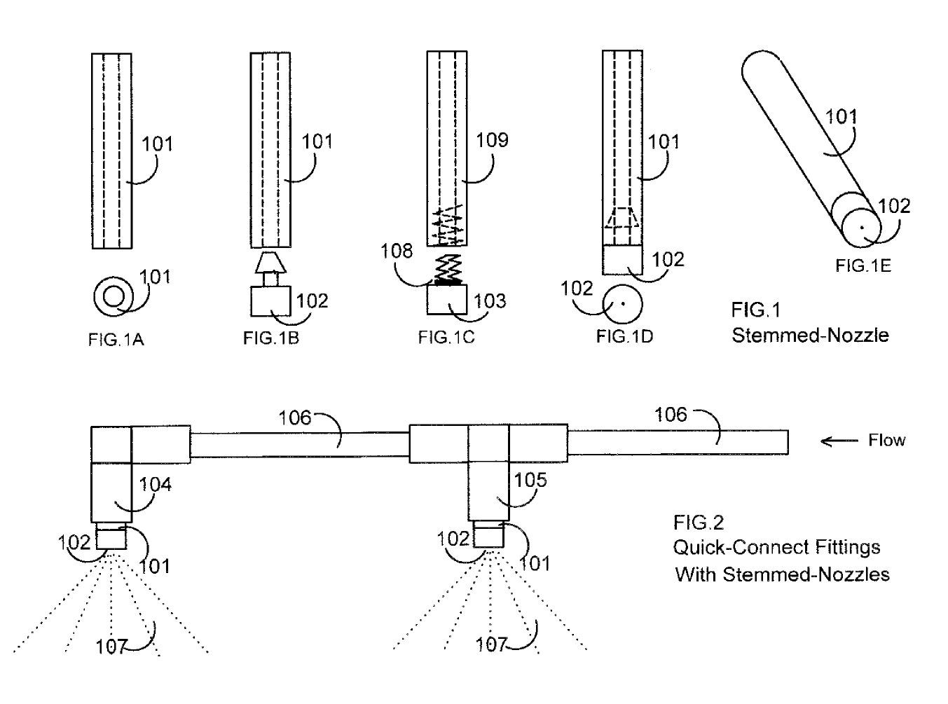

FIG. 1 illustrates an embodiment of the invention in which the Stemmed-Nozzle utilizing the two most common types of nozzles, the Barbed-Nozzle and the Threaded-Nozzle.

FIG. 1A illustrates an embodiment of a rigid Hollow-Cylindrical Stem 101, which could be made of rigid plastic or metal.

FIG. 1B illustrates an embodiment of a Barbed-Nozzle 102 that is pressed into a Hollow-Cylindrical rigid stem 101. The process could be done manually through a hand-press, or using a power-press. No need for o-rings, because the Barbed-Nozzle locks inside the stem and forms a seal that prevents any leakage, because the two parts become one integral unit.

FIG. 1C illustrates an embodiment of a Threaded-Nozzle 103 that is screwed into a threaded Hollow-Cylindrical rigid stem 109. An O-Ring 108 is needed at the base of the male threads of the Threaded-Nozzle. The Threaded-Nozzle is screwed into the threaded stem and locks in, the O-ring prevents any leakage.

FIG. 1D illustrates an embodiment of an assembled (pressed-in) Stemmed-Barbed-Nozzle 101+102. The Stemmed-Barbed-Nozzles is the most economical way for making the Stemmed-Nozzles, they can be Pressed-in, or the plastic stem could be directly molded over the barb. The Barb bites into the stem and forms a seal preventing any leak hence no need for an O-Ring. It also locks in preventing the Barbed-Nozzle from popping out when pressure builds up.

FIG. 1E illustrates an embodiment of an assembled Stemmed-Nozzle 101+102 in three dimensions perspective view. The nozzle could be either barbed or threaded, and can be made of plastic or metal.

FIG. 2 illustrates an embodiment of a Misting system utilizing Quick-Connect fittings and Stemmed-Nozzles. Quick-Connect fittings come in variety of sizes and shapes, and FIG. 2 shows the stemmed-Nozzle 101+102 assembled to a Quick-Connect Elbow 104, and a Quick-Connect Tee 105, which in turn are connected to tubing 106. The tubing would be attached to a water source, such as a garden hose faucet (through an adaptor fitting), or to a booster pump to boost water pressure (or drawing from a tank of water), (other applications could use other liquids or gases).

Assembling

The Barbed-Nozzle 102 is placed over a press, and a rigid plastic hollow-Cylindrical stem 101 is placed over it, lining up the tip of the barb with the hole of the hollow stem, then the press handle is pulled down, (a power press could be used as an alternate), and the two pieces are pressed together, locking the Barbed-Nozzle securely inside the plastic stem, and turning it into one integral part of a Stemmed-Nozzle.

For mass production the plastic stem could be molded right over the Barbed-Nozzle, this would be the most economical way for production. Threaded stems could also be molded and those would require Threaded-Nozzles.

An alternate would be the use of a threaded metal stem or a threaded plastic hollow stems 109, where the threaded-Nozzle 103 is screwed into that stem, in this case an O-Ring 108 is needed to prevent leakage. This process is less economical than the Stemmed-Barbed-Nozzle system, and requires more labor (screwing).

Quick-Connect Fittings are made of either plastic or metal, there are several companies that manufacture them, and they come in a variety of standard sizes such as ¼″, ⅜″, and ½″ Inside Diameters etc. Inside the fitting they have rubber O-ring(s) and a plastic collet (plastic ring) with teeth/prongs, through which the stem (or tubing) is locked inside the fitting (as the water pressure builds up).

Using Barbed-Nozzles with plastic stems along with plastic fittings is most economical, and that could be applied for low and medium pressure misting systems. For high pressure misting systems metal stems, fittings and tubing must be used to withstand the higher pressure.

Starting at the end of a misting line with an Elbow 104 (or a union), the Stemmed-Nozzle 101+102 is pushed all the way into this Quick-Connect elbow fitting, this locks it in place, then the tube 106 is cut to length (normally 2′ long=the spread of the mist), and inserted into the other end of the elbow. The other end of the tube is connected to a Tee Quick Connect fitting 105, while another two feet of tubing 106 is attached to the second end of that Tee, and a stemmed-Nozzle 101+102 is inserted into the third end of the tee fitting.

What follows is repeating the Tee connections, adding the Stemmed-Nozzles (as much as needed, and as water flow and pressure allows), and running the tubing and expanding (like a Christmas tree lights), ending the line with a Garden Hose Faucet adaptor fitting that is attached to a Garden Hose Faucet to deliver the pressured water. The misting system would work on city water pressure, as long as the pressure is above 45 psi. When the garden hose faucet is turned on, the mist is generated, and temperature is dropped by up to 25 Degrees Fahrenheit, based on the scientific concept of evaporative cooling.

Nozzles are normally made of Brass casing with Stainless Steel nozzle orifice core, some are made from molded plastic (and that is the low end). The higher the metal grade the better the nozzle handles higher pressure and generates finer mists.

A Stemmed-Nozzle could also be made totally from plastic, or plastic with the core orifice made of metal, or metal (Copper, Brass or Brass and Stainless Steel) plus metal or rigid plastic stem.

### CONCLUSION

Accordingly, the reader will see the advantage of the Stemmed-Nozzle, which generates a simple, quick and easy way of making misting systems that can be used for a large variety of applications. One of which is outdoor cooling affordable to the average person.

Although the description above contains many specifications, these should not be construed as limiting the scope of the invention but as merely providing illustrations of some of the presently preferred embodiment of the invention.

The scope of the invention should be determined by the appended claims and their legal equivalents, rather than by the examples given.

What is claimed is:

1. An article consisting of a nozzle that is securely attached to one end of a hollow cylindrical rigid stem of sufficient length, and with proper inner and outer diameters, both nozzle and stem form one integral part.

2. A configuration that allows a nozzle to be connected to a quick-connect fitting, comprising: A hollow cylindrical rigid stem of sufficient length, and with proper inner and outer diameters, where a nozzle is securely attached to it at one of its ends, allowing the stem's other end to be connected to a quick-connect fitting, which is done by pushing it into the fitting's opening, locking the Stemmed-Nozzle in.

3. An article for delivering mist or fog, for use with quick-connect fitting, comprising: A Barbed-Nozzle pressed into a sufficient length hollow cylindrical rigid stem with proper inner and outer diameters, where the nozzle is pressed into the stem to form a Stemmed-Nozzle.

4. The Stemmed-Nozzle of claim 3, wherein said article is made of a Barbed-Nozzle and the hollow stem made of plastic that is molded over the barbed end of the nozzle forming the Stemmed-Nozzle.

5. The Stemmed-Nozzle of claim 3, wherein said article is made of a female threaded hollow rigid Stem that matches the male threaded end of a Threaded-Nozzle, where the nozzle is screwed into the stem to form a Stemmed-Nozzle.

6. The Stemmed-Nozzle of claim 3, wherein said article is made of molding the nozzle and the cylindrical hollow rigid stem both together out of plastic, to form a Stemmed-Nozzle.

7. The Stemmed-Nozzle of claim 3, wherein said article is made of a nozzle that is attached to a metal stem with proper groves for coupling with high pressure quick connect fittings, for high pressure application.

8. The Stemmed-Nozzle of claim 3, wherein said article is made of any material, or combination of materials.

9. A Stemmed-Nozzle whose components are securely attached together using any process, and/or using any bonding material depending on type of components used.

10. A Stemmed-Nozzle that Slips-in and Locks-in, into a Quick-Connect fitting.
